(19) United States
(12) Patent Application Publication
(10) Pub. No.: US 2025/0331637 A1
(43) Pub. Date: Oct. 30, 2025

(54) MODULAR AND POLYVALENT TOP PANEL FOR FURNITURE

(71) Applicant: Home Depot Authority, LLC, Atlanta, GA (US)

(72) Inventor: Michele ZUCCA, Petriano (IT)

(21) Appl. No.: 18/870,012

(22) PCT Filed: May 4, 2023
(86) PCT No.: PCT/EP2023/061817

§ 371 Date: Nov. 27, 2024

(30) Foreign Application Priority Data
May 27, 2022 (IT) 102022000011135

(51) Int. Cl. A47B 96/20; A47B 13/08

(52) U.S. Cl. CPC A47B 96/206; A47B 13/088

(57) ABSTRACT

Modular and polyvalent top panel for furniture, particularly of the most common type consisting of plywood such as chipboard or MDF (medium-density fibreboard) vencered with plastic paper coatings on planar extensions and edges, comprising—on the perimeter of a lower face (3A,B) and however on a face (3A,B) of the panel (1A,B) not exposed in use—at least one seat (9A,B) for hardware (15) which can be concealed with a mask (14) and defined—on a portion thereof—by a breakable edge (13) in the edging (8A,B) preferably narrowed; said at least one seat (9A,B) being sized, oriented and positioned to be suitable—in use—to interface similar at least one seat (9A,B) of another complementary panel (1A,B) for being exposed in a combined fashion and arranged one after the other in order to house at least one tensioning mechanical device (15) suitable to join the two panels (1A,B) in a coplanar manner in use especially to form an angular assembly.

### DETAILED DESCRIPTION

### Field of the Art

In the furniture industry there is an increasingly higher need for focus to reduce the storage of semi-finished elements forming the pieces of furniture, so as to directly proportionally reduce—as a result—the assets, storage spaces and management costs.

Where possible, such objects are at least partly actually attained with one batch and on demand productions.

Even where the high production volume and production massification for large-scale distribution does not make one batch production or on-demand production feasible, focus on reducing storage still persists, at least in the sense of having leaner logistics and management.

Examples of the known art are given:
international patent application publication No. WO2005/085657A1 dated 15 Sep. 2005 in the name of Rapiojoint Pty Ltd,
international patent application publication No. WO03/095847A1 dated 20 Nov. 2003 in the name of Scott Smith,
german patent application publication No. DE4133520A1 dated 22 Apr. 1993 in the name of Duerkopp Adler A G,
international patent application publication No. WO92/06620A1 dated 30 Apr. 1992 in the name of Nikolaos Kokkalas, and
german utility model No. DE9216069U1 dated 31 Mar. 1994 in the name of Werner Rohe.

### OBJECTS OF THE INVENTION

In this context, the main object of the present invention is to provide an innovative solution suitable to contribute to providing polyvalent semi-finished products for making the warehouse lean by reducing storage spaces and management codes in the furniture industry and in particular in the massified production industry.

Another object of the present invention is to achieve the preceding object through a solution that is easy to implement on the existing production lines that does not require particular adaptations of the latter.

Yet another object of the present invention is to achieve the preceding objects through a solution adopting components that are easily available on the market, and in any case without additional costs which nullify the advantages thereof.

Another object of the present invention is to achieve the preceding objects through a solution concept that is simple and efficient, safe in use and a relatively cost-effective considering the results practically attainable therewith.

### SUMMARY OF THE INVENTION

These and other objects are all achieved through the modular and polyvalent top panel for furniture, according to the present invention, particularly of the most common type consisting of plywood such as chipboard or MDF (medium-density fibreboard) veneered with plastic paper coatings on planar extensions and edges, comprising—on the perimeter of a lower face (3A,B) and however on a face (3A,B) of the panel (1A,B) not exposed in use—at least one seat (9A,B) for hardware (15) which can be concealed with a mask (14) and defined—on a portion thereof—by a breakable edge (13) in the edging (8A,B) preferably narrowed; said at least one seat (9A,B) being sized, oriented and positioned to be suitable—in use—to interface similar at least one seat (9A,B) of another complementary panel (1A,B) for being exposed in a combined fashion and arranged one after the other in order to house at least one tensioning mechanical device (15) suitable to join the panels (1A,B) in a coplanar manner in use especially to form an angular assembly.

### DESCRIPTION OF THE ATTACHED DRAWINGS

Further characteristics and advantages of the modular and polyvalent top panel for furniture according to the present invention shall be more apparent from the following detailed description of a preferred but non-exclusive embodiment thereof, represented solely by way of non-limiting example in the six attached drawings, wherein:

FIGS. 1 to 5 are bottom perspective views of two modular and polyvalent top panels for furniture according to the present invention in an equal number of relative interaction exemplifying steps;

FIG. 6 shows a detail of FIG. 5.

FIGS. 7 and 8 show an alternative embodiment of the panel according to the present invention.

### STATIC DESCRIPTION OF THE EMBODIMENT

With reference to such figures, two rectangular panels designed to form the top plane of furniture, so-called top at all, in particular work surfaces for kitchen furniture, especially of the large-scale serial industrial production type, are indicated in their entirety respectively with 1A and 1B.

The panels 1A and 1B of the shown embodiment shall be deemed identical in terms of construction and size, made—for example and usually like in the case of wood substitutes such as chipboard or MDF—veneered like it happens with melamine paper and/or laminate and edged using the same materials and implementing the prior art.

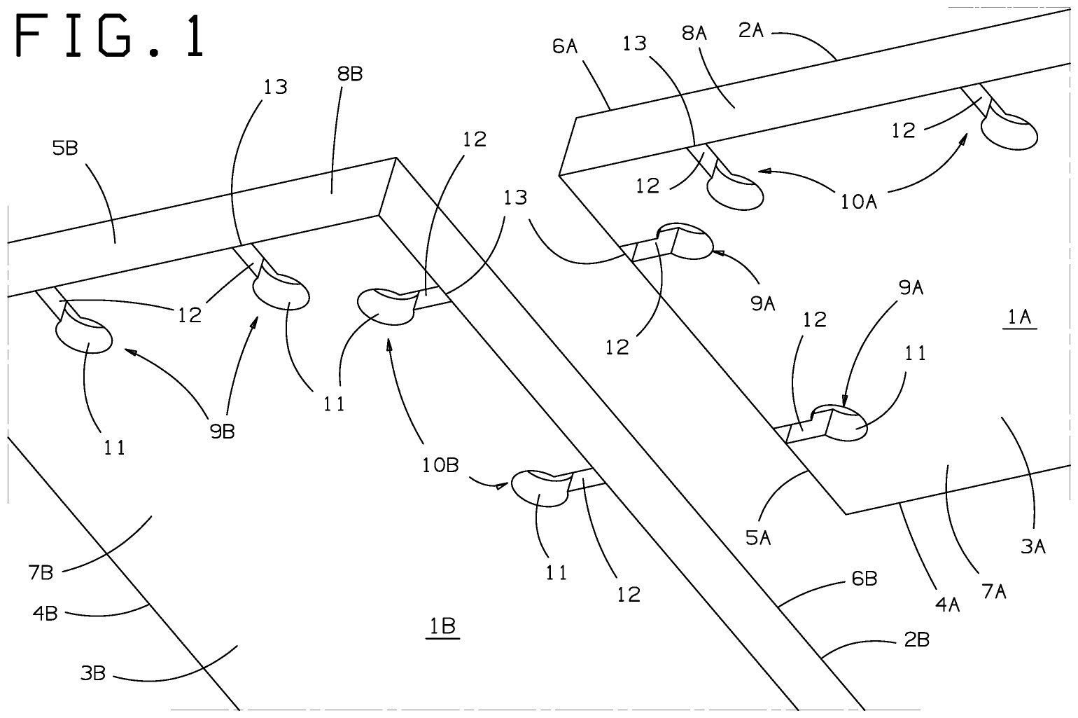

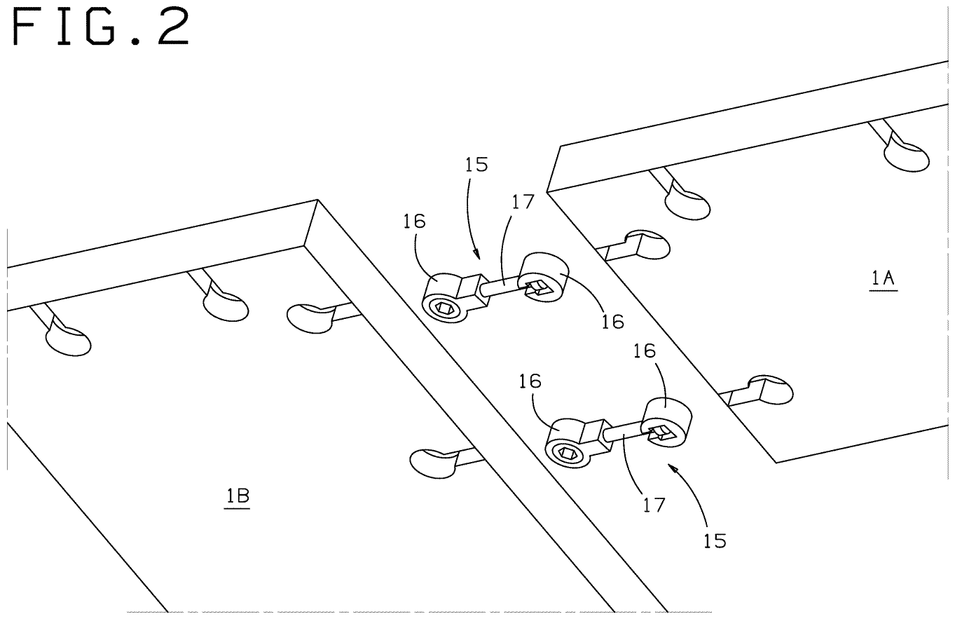

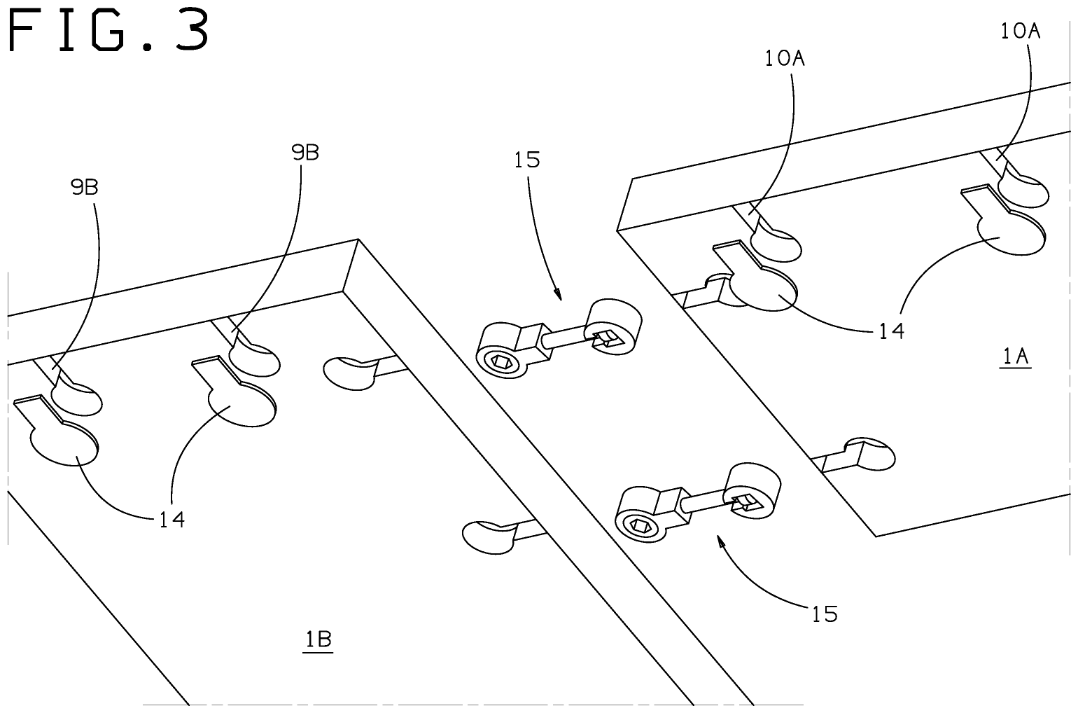

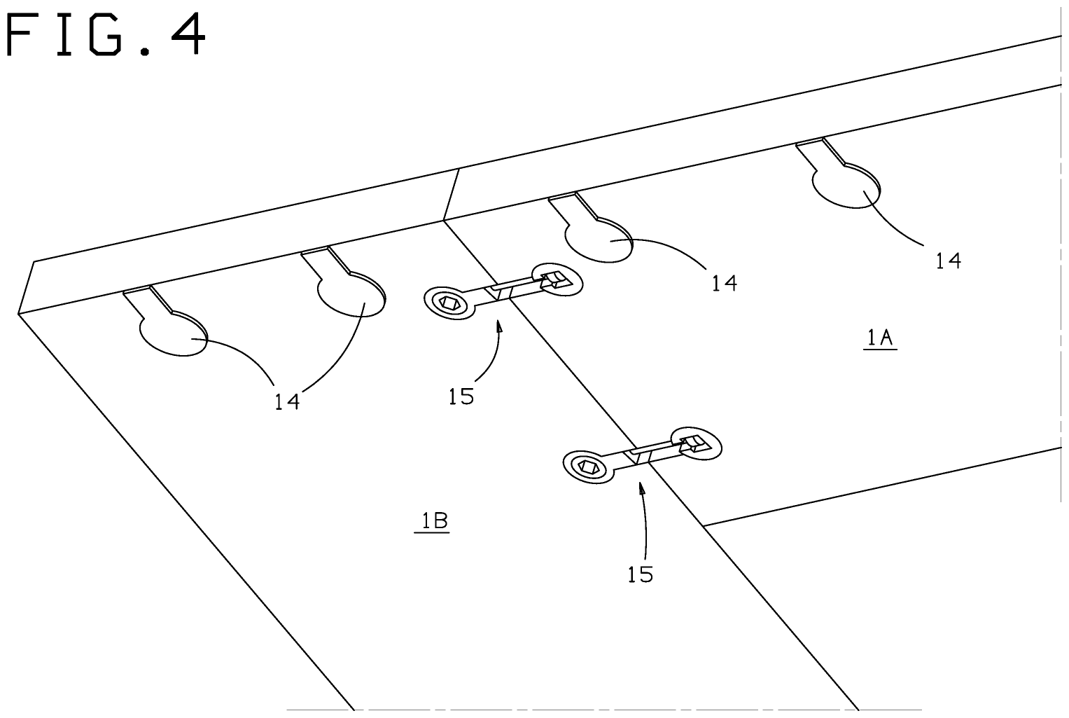

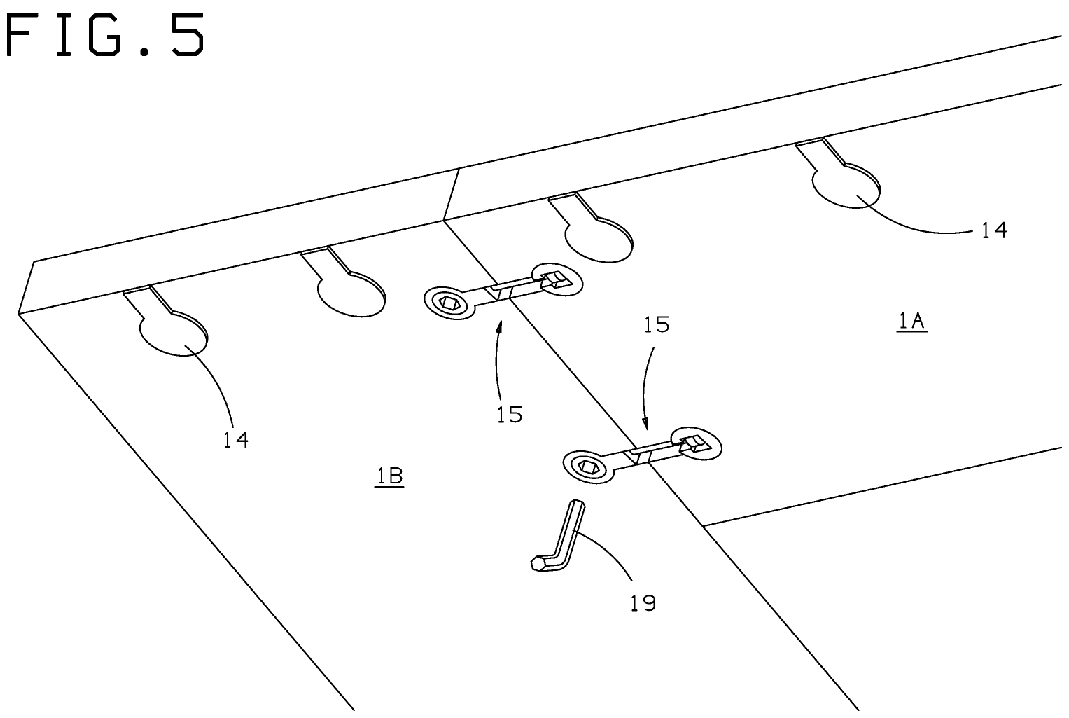

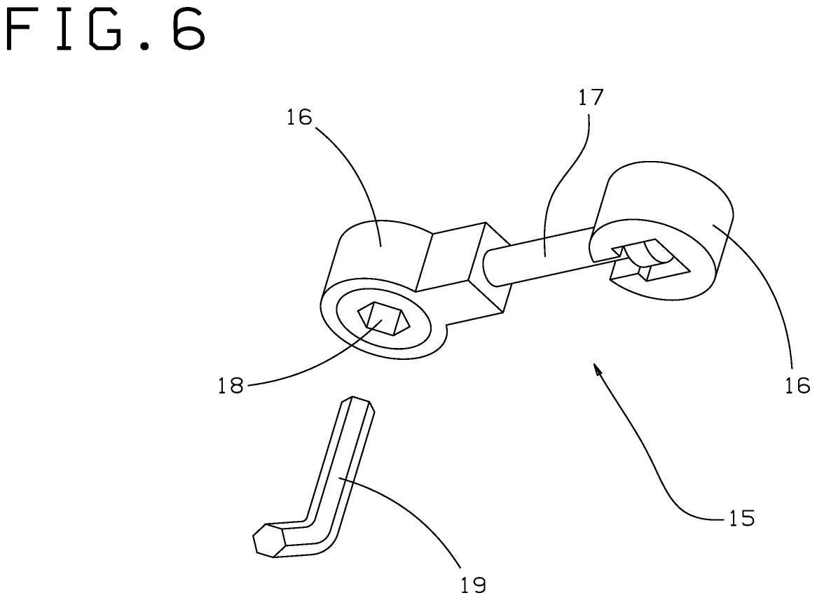

In all FIGS. 1 to 5, the two top panels 1A and 1B are bottom perspective views, indicated therein with 3A and 3B are the respective lower faces, with 2A and 2B the respective upper faces, with 4A and 4B the respective larger sides and with 5A and 5B the respective smaller sides.

For example, and preferably the respective upper faces 2A and 2B are coated with a laminate made of PVC 6A and 6B, the respective lower faces 3A and 3B are coated with melamine paper 7A and 7B, the respective larger sides 4A, 4B and smaller sides 5A, 5B are edged with laminated edges made of PVC 8A and 8B, preferably with low thickness for the functions subsequently described better below.

On the lower face 3A of the first top panel 1A, at the smaller sides 5A there are formed—preferably by milling subsequently to veneering—a pair of seats or recesses 9A equally spaced from the edges which define the smaller side 5A of reference.

Similarly, on the lower face 3B of the second top panel 1B, at the smaller sides 5B there are formed—preferably by milling subsequently to veneering—a pair of seats or recesses 9B equally spaced from the edges which define the smaller side 5B of reference.

On the lower face 3A of the first top panel 1A, at the larger sides 4A, there are formed a pair of seats or recesses 10A, identical to the seats or recesses 9A of the smaller sides 5A and like the latter mutually interspaced and arranged against the edge of the closest smaller side 5A.

Similarly, on the lower face 3B of the second top panel 1B, at the larger sides 4B, there are formed a pair of seats or recesses 10B, identical to the seats or recesses 9B of the smaller sides 5B and like the latter mutually interspaced and arranged against the edge of the closest smaller side 5B.

All seats or recesses 9(A, B) and 10(A, B) are identical in terms of size and shape, which comprises a substantially circular inner portion 11 and a contiguous groove 12 perpendicular to the reference edge 8(A, B);
more specifically, each groove 12—during the formation thereof—remains occluded and blocked by the reference edge 8(A, B), but suitable to terminate outside by simply cutting and removing the thin edging wall 8(A, B), that is the breakable edge 13 that occludes it here, for the functions described better below.

All seats or recesses 9(A, B) and 10(A, B) are suitable to be masked by covering and occlusion adhesive patches 14, preferably made of the same coating material 7(A, B) which covers the lower faces 3(A, B) of the panels 1(A, B).

Tensioners, to be intended as hardware of any kind suitable for the purpose available on the market, of the kind comprising two apical heads 16 joined by a shank 17 suitable to be mechanically shortened using a screw mechanism 18 inserted into at least one of the heads 16, which can be actuated using any wrench 19, for the purposes outlined hereinafter, are indicated in their entirety respectively with 15.

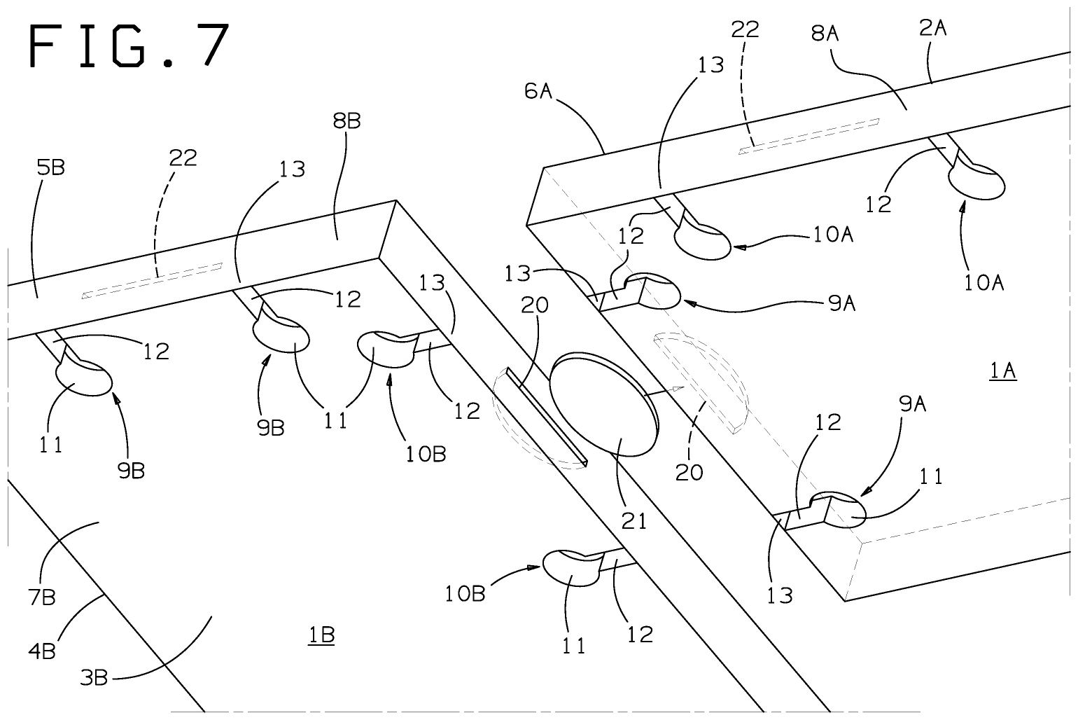

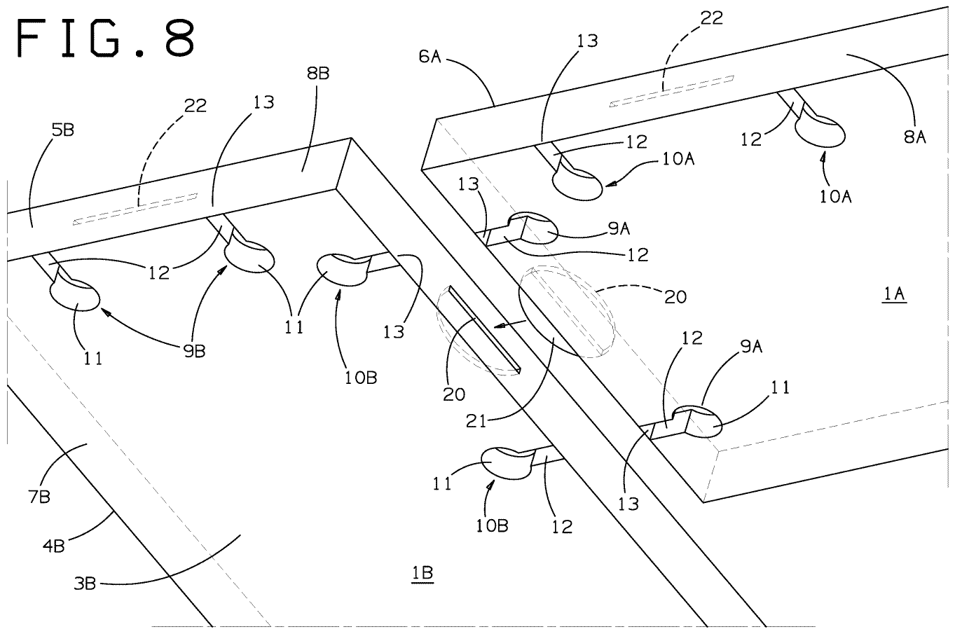

In the embodiment shown in FIGS. 7 and 8, the furniture top panel according to the present invention comprises alignment milling-pre-cuts 20 on the sides 4A and 4B, 5A and 5B suitable for accommodating respective fixing dowel-plates 21 of coplanar attachment of other complementary panel 1A and 8B provided with homologous interfaced alignment millings-pre-cuts 20 on the sides 4A and 4B, 5A and 5B, said alignment millings-pre-cuts 20 being covered with edging material 8A and 8B and activated in case of use by locally cutting and/or removing the link bridge 22 of edging material 8A and 8B covering them.

### Dynamic Description of the Embodiment

Thus, having completed the static description of one preferred embodiment of the modular and polyvalent top panel for furniture according to the present invention, below is the dynamic description, that is the relative operation:

The panels 1(A, B) are produced, coated and edged according to the prior art, with the particular solutions for thickening the panel and robustness of the coatings, especially on the upper face 2(A, B), required and suitable for their intended use to form top planes for furniture, so-called top, in particular work surfaces for kitchen furniture, which—as work surfaces—require particular robustness and strength against scratches and abrasions.

Once completed in the relative preparation processes according to the prior art, the panels 1(A, B) according to the invention are subjected to further processes to obtain by milling the seats or recesses 9(A, B) and 10(A, B) on the lower face 3(A, B), which are then masked by the adhesive patches 14.

Therefore, the panels 1(A, B) according to the invention may be used for assembling the piece of furniture as a whole, like their similar elements according to the prior art, wherein the seats or recesses 9(A, B) and 10(A, B) are not observable due to the fact that they are closed on the sides 4(A, B) and 5(A, B) by the edges 8(A, B) and concealed on the lower face 3(A, B) by the patches 14.

Should a piece of furniture instead provide for a straight corner work surface, two panels 1A and 1B can be angularly joined also to meet the needs of such application, which can be polyvalently used without the need for specific panel components provided, stored and encoded for this purpose:
depending on the dimensional configuration of the work surface to be obtained, the seats or recesses 9(A, B) e 10(A, B) may be exposed and arranged interfaced in various combinations to receive the tensioners 15, which angularly join the two panels 1A and 1B once tightening has been completed.

In greater detail, and by way of example, to continue the functional illustration of FIGS. 1 to 5:
the adhesive patches 14, if already previously applied, can be removed to expose the two seats or recesses 9A on a smaller side 5A of the first panel 1A and the two seats or recesses 10B on a larger side 4B of the second panel 1B;
therefore portions 13 of the edges 8A which occlude the groove-like portions 12 of the two seats or recesses 9A on the smaller side 5A of the first panel 1A and of the portions 13 of the edges 8B which occlude the groove-like portions 12 of the two seats or recesses 10B on the larger side 4B of the second panel 1B, are removed by cutting;
at this point, the smaller side 5A of the first panel 1A and the larger side 4B of the second panel 1B may be counter-faced, so that they mutually perfect match the terminations of the groove-like portions 12 of the two seats or recesses 9A of the smaller side 5A of the first panel 1A with the terminations of the groove-like portions 12 of the two seats or recesses 10B of the larger side 4B of the second panel 1B.

In an arrangement thus made, the shanks 17 of a pair of tensioners 15 can be inserted into the groove-like portions 12 thus made complementary, with the relative heads 16 respectively embedded into the circular portions 11 of the two seats or recesses 9A of the smaller side 5A of the first panel 1A and of the two seats or recesses 10B of the larger side 4B of the second panel 1B.

Then, by tightening the tensioners using the respective screws 18 with the tool 19, the panels 1A and 1B are therefore angularly joined and welded, given that for this purpose, as mentioned at the beginning, the thickness of the edging 8(A, B) is reduced, so that the aesthetic interruption in the joint remains less evident.

In the embodiment illustrated in FIGS. 7 and 8, the furniture top panel according to the present invention comprises alignment milling-pre-cuts 20 on the sides 4A and 4B, 5A and 5B suitable for accommodating respective fixing dowel-plates 21 of coplanar attachment of other complementary panel 1A and 1B provided with homologous interfaced alignment milling-pre-cuts 20 on the sides 4A and 4B, 5A and 5B, said alignment milling-pre-cuts 20 being covered with edging material 8A and 8B and activated in case of use by locally cutting and/or removing the link bridge 22 of edging material 8A and 8B covering them; all to further stabilise the assembly without the appearance of the stabilisation recesses 20 when not in use.

### Alternative embodiments

It is obvious that in further alternative embodiments, still falling within the innovation concept subject of the embodiment illustrated above and claimed below, the modular and polyvalent top panel for furniture according to the present invention, may be implemented through equivalent technical and mechanical solutions, that is provided with further supplementary solutions, just like—in the claimed scope—all elements they are made of may vary in a manner suitable for the purpose and adapted to the specific conformation and structure.

In particular:
the seats or recesses for the tensioners can be shaped and concealed in any other manner suitable for the purpose;
the panels, which in the shown embodiment were presumed identical, may be otherwise shaped;
the recesses may be provided for on all the sides of the panels and vary in number and mutual arrangement suitable for the purpose.

### Advantages of the Invention

As observable from the preceding detailed description of a preferred embodiment, the modular and polyvalent top panel for furniture according to the present invention, offers the advantages corresponding to the attainment of these and other pre-set objects:
as a matter of fact it allows to obtain a semi-finished structure for forming work surfaces in furniture suitable to meet a plurality of implementation needs with unique structure, therefore contributing to reducing the semi-finished products to be produced, stored and managed in manufacturing pieces of furniture especially kitchen furniture and in particular in large-scale serial production, even in supplying assembly boxes to be assembled by the end customers.

### KEY TO REFERENCE NUMBERS

1A) first top panel
1B) second top panel
2A) upper face of the first top panel
2B) upper face of the second top panel
3A) lower face of the first top panel
3B) lower face of the second top panel
4A) larger sides of the first top panel
4B) larger sides of the second top panel
5A) smaller sides of the first top panel
5B) smaller sides of the second top panel
6A) coating of the upper face of the first top panel
6B) coating of the upper face of the second top panel
7A) coating of the lower face of the first top panel
7B) coating of the lower face of the second top panel
8A) laminated edges of the first top panel
8B) laminated edges of the second top panel
9A) seats or recesses at the smaller sides of the first top panel
9B) seats or recesses at the smaller sides of the second top panel
10A) seats or recesses at the larger sides of the first top panel
10B) seats or recesses at the larger sides of the second top panel
11) circular portion of the seats or recesses
12) groove-like portion of the seats or recesses
13) breakable edge portion of the seats or recesses
14) adhesive patches of the seats or recesses
15) tensioners as a whole
16) heads of the tensioners
17) shank of the tensioners
18) screw of the tensioners
19) tool of the tensioners
20) alignment milling-pre-cuts
21.) dowel-plates
22) link bridge of edging material covering the alignment milling pre-cuts

1) Modular and polyvalent top panel for furnishing pieces of furniture, particularly of the type consisting of plywood such as chipboard or MDF (medium-density fibreboard) veneered with plastic and/or paper coatings on planar extensions and sides, characterised in that it comprises:
recesses (9A,B-10A,B) excavated on a lower face (3A,B) and in any case on a face (3A,B) of the panel (1A,B) not exposed in use, terminating outside on the sides (4A,B, 5A,B) of the panel (1A,B);
covering means (14, 8A,B) to conceal and disguise on the lower face (3A,B) and on the sides (4A,B, 5A,B) said recesses (9A,B-10A,B) consisting of portions of the same plastic and/or paper coverings (6A,B, 7A,B, 8A,B) that coat the faces (2A,B-3A,B) and/or the sides (4A,B, 5A,B) of the panel (1A,B);
means of removal of said covering means (14) to uncover those recesses (9A,B-10A,B) which in use constitute a seat for a portion of one tensioning hardware (15) which provides a seat for the further portion thereof in one similar recess (9A,B-10A,B) which can be concealed using similar cover means (14, 8A,B) excavated on a lower face (3A,B) and in any case on a face (3A,B) not exposed in use terminating outside on the sides (4A,B, 5A,B) of similar cooperating panel (1A,B) arranged adjacent.

2) Top panel for furnishing pieces of furniture according to claim one, characterised in that said recesses (9A,B-10A,B) are defined on a respective portion thereof by means of a breakable edge (13) consisting of a segment incident therein of the covering means (8A,B) formed by the edging (8A,B) of the sides (4A,B, 5A,B) of the panel (1A,B).

3) Top panel for furnishing pieces of furniture according to the preceding claims, characterised in that the edging (8A,B) of the sides (4A,B, 5A,B) of the panel (1A,B) is narrowed with respect to the size of the usual edgings of the top panel for furnishing pieces of furniture according to the prior art.

4) Top panel for furnishing pieces of furniture according to the preceding claims, characterised in that it comprises seats (9A,B) for hardware (15) on the perimeter of a lower face (3A,B) and however on a face (3A,B) of the panel (1A,B) not exposed in use which can be concealed with a mask (14) consisting of portions of the same plastic and/or paper coatings (6A,B, 7A,B) covering the faces (2A,B, 3A,B) of the panel (1A,B) and defined—on a portion thereof—by a breakable edge (13) consisting of a portion of the edging (8A,B); of the sides (4A,B, 5A,B) of the panel (1A,B); said seats (9A,B) being sized, oriented and positioned to be suitable—in use—to interface similar seats (9A,B) for hardware (15) of another complementary panel (1A,B) for being exposed in a combined fashion and arranged one after the other in order to house one tensioning mechanical device (15) suitable to join the two panels (1A,B) in a coplanar manner in use especially to form an angular assembly.

5) Top panel for furnishing pieces of furniture according to the preceding claims, characterised in that it comprises:
producing in form of chipboard or MDF (medium-density fibreboard), veneering with melamine paper coating and/or plastic laminate (6A,B, 7A,B) and edging (8A,B) using the same materials;
a lower face (3A,B) at whose smaller sides (5A,B) there are formed by milling a pair of recesses or seats (9A,B) terminating outside on the sides (4A,B, 5A,B) and equally spaced from the edges that define the smaller side (5A,B) of reference;
a lower face (3A,B) at whose larger sides (4A,B) there are formed by milling a pair of recesses or seats (10A,B) terminating outside on the sides (4A,B, 5A,B) and equal to the recesses or seats (9A,B) of the smaller sides (5A,B) and like the latter mutually interspaced and arranged against the edge of the closest smaller side (5A,B).

6) Top panel for furnishing pieces of furniture according to the preceding claim, characterised in that all the seats or recesses (9A,B-10A,B) are equal to the size and conformation which comprises a substantially circular inner portion (11) and an adjacent groove (12) perpendicular to the side (5A,B, 6A,B) of reference.

7) Top panel for furnishing pieces of furniture according to the preceding claim, characterised in that each groove (12) is occluded and barred by the edge (8A,B) of reference and suitable to terminate outside by cutting and removing the edging portion (8A,B) consisting of a breakable edge (13) that occludes it thereon.

8) Top panel for furnishing pieces of furniture according to the preceding claim, characterised in that all the recesses or seats (9A,B-10A,B) are masked by covering and occluding adhesive patches (14) suitable to be removed and relocated.

9) Top panel for furnishing pieces of furniture according to the preceding claims, characterised in that that all recesses or seats (9A,B-10A,B) are shaped to accommodate tensioners (15) which comprise two apical heads (16) joined by a shank (17).

10) Top panel for furnishing pieces of furniture according to the preceding claim, characterised in that within two of said substantially circular inner portions (11) of said seats or recesses (9A,B-10A,B) are respectively inserted the apical heads (16) of said tensioners (15) and that said shanks (17) of said tensioners (15) are inserted inside two grooves (12) of said seats or recesses (9A,B-10A,B) arranged one after the other.

11) Top panel for furnishing pieces of furniture according to the preceding claim, characterised in that it comprises alignment milling-pre-cuts (20) in the sides (4A,B 5A,B) suitable for housing respective fixing dowel-plates (21) for coplanar fixing of other complementary panel (1A,B) equipped with homologous alignment millings-pre-cuts (20) in the sides (4A,B 5A,B), said alignment milling-pre-cuts (20) being covered with edging material (8A,B) and can be activated when in use by cutting and/or locally removing the link bridge (22) of edging material (8A,B) covering them.
